(19) United States
(12) Patent Application Publication
(10) Pub. No.: US 2011/0077977 A1
(43) Pub. Date: Mar. 31, 2011

(54) METHODS AND SYSTEMS FOR DATA MINING USING STATE REPORTED WORKER'S COMPENSATION DATA

(76) Inventors: Dean Collins, Manchester, CT (US); Adam Kaprove, South Windsor, CT (US); Paul Ramont, West Hartford, CT (US)

(21) Appl. No.: 12/844,358

(22) Filed: Jul. 27, 2010

Related U.S. Application Data
(60) Provisional application No. 61/229,166, filed on Jul. 28, 2009.

(51) Int. Cl. G06Q 40/00; G06F 17/30

(52) U.S. Cl. 705/4; 707/755; 707/E17.005

(57) ABSTRACT

A worker compensation data mining computer system includes a data collection computer interface receiving worker's compensation data, optionally stored by a third party data provider or a state database, and a data mining computer processing unit analyzing the worker's compensation data to determine trends in the worker's compensation data. The data mining computer processing unit generates one or more of the following: a fraud communication, a model, a predictive variable, a marketing communication, a sales communication, a pricing communication, a prospecting communication, a ratings communication, a sales communication, and an underwriting communication. The system also optionally includes a modeling computer processing unit, that analyzes one or more of the worker's compensation data, underwriting models, sales models, pricing models, ratings models, marketing models, fraud models, and prospecting models, to determine whether to modify the at least one of the models. Computer implemented methods of generating alerts, insurance premiums, pricing an insurance policy, and alternative embodiments are also disclosed.

### CROSS REFERENCE TO PRIOR APPLICATIONS

This application claims priority to U.S. Provisional Application Ser. No. 61/229,166, filed on Jul. 28, 2009, which is incorporated by reference herein in its entirety.

### BACKGROUND

By law, worker's compensation insurance is required to be purchased by most employers. It is used to provide compensation to a worker who is injured on the job. The Worker's compensation market is highly fragmented and as a result no single insurer has a dominant market share. This in turn means that each insurer cannot, using their own sources, gather enough statistical data/information to provide adequate information regarding insurance policies and/or insureds.

There are many sources of worker's compensation information, such as from Insurance Services Office (ISO) or state specific sources such as Electronic Data Exchange (EDEX). However, this information is subject to limited availability and not all providers allow mining of their data. Individual inquiries are possible, but ISO will not provide a large dataset such as what may be available from states.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements.

FIG. 1 is a system diagram of at least one embodiment showing the overall architecture for processing state worker's compensation injury data.

FIG. 2 is a flow diagram showing at least one embodiment of the overall process for processing state worker's compensation injury data.

FIG. 3 is a flow diagram showing at least one embodiment of using anonymized data.

FIG. 4A is a flow diagram showing for prospecting using the worker's compensation data according to an embodiment of the invention.

FIG. 4B is a flow diagram showing for detecting potential fraud using the worker's compensation data according to an embodiment of the invention.

FIG. 4C is a flow diagram showing for calculating ratings of policies using the worker's compensation data according to an embodiment of the invention.

FIG. 4D is a flow diagram showing for calculating ratings of policies using the worker's compensation data according to an embodiment of the invention.

FIG. 5 is a flow diagram showing analytics of worker's compensation data according to an embodiment of the invention.

### DETAILED DESCRIPTION

Worker's compensation laws differ from state to state, but most states require that each injury covered by worker's compensation laws be reported to the state. For example, in Connecticut, the statute requires employers to report any injury that results in an employee missing one or more days of work. States keep these records of worker's compensation claims, and some of them require the injury reports to be made electronically. Worker's compensation claim data has been reported to states for decades. In the past, this data was held in paper form. Since Electronic Data Interchange (EDI) standards became prevalent, data has now started to be collected by states in digital form.

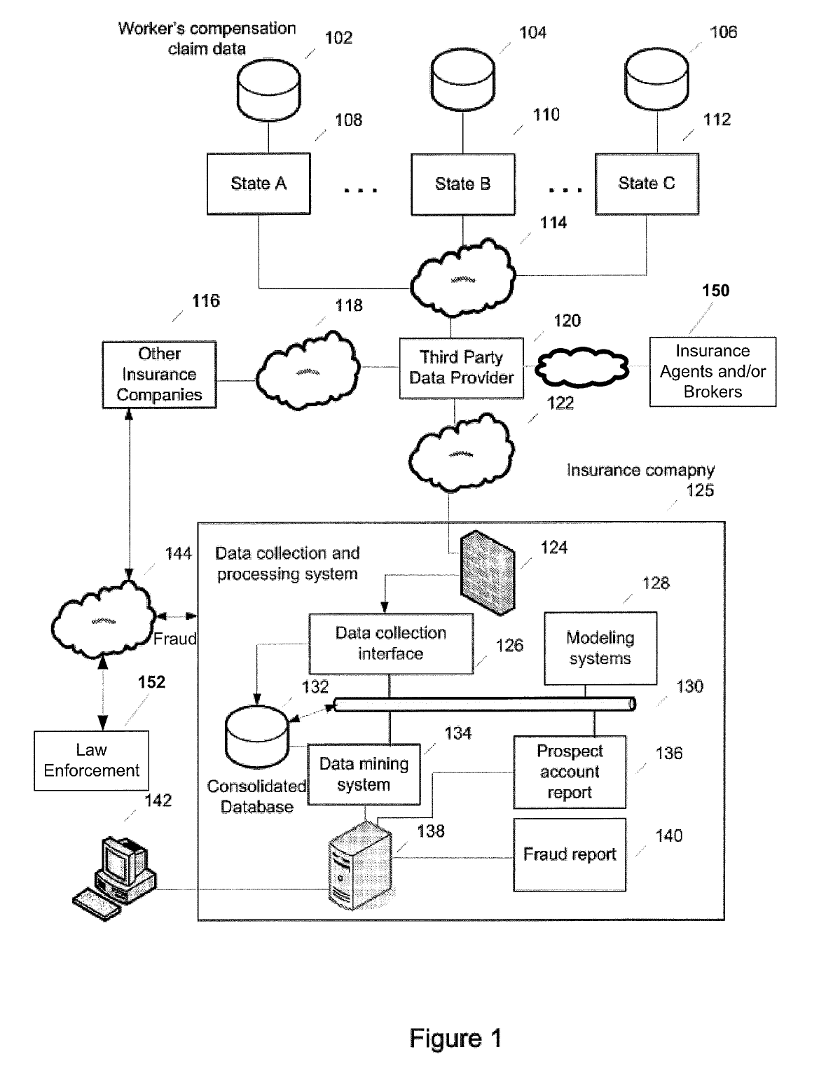

FIG. 1 is a system block diagram of one embodiment showing the overall architecture for processing state worker's compensation injury data. Each of the states 108, 110, and 112 has its own source of injury data, which are databases 102, 104, and 106, respectively. The states can provide this injury data to a third party data provider 120 through electronic communication network (e.g. Internet) 114. Although FIG. 1 shows the third party data provider 120 receiving data from multiple states 108, 110, and 112, the third party data provider 120 may receive data from a single state. Further, the insurance company 125 may elect to receive data from multiple states or data from a single state from the third party data provider 120. The third party data provider may also share the data it receives from the one or more states 108, 110, and 112 with insurance agents and/or brokers 150. As described below, the third party data provider can request this data periodically, or in response to a request from an insurer. In addition to collecting the data from each of the states 108, 110, and 112, the third party data provider 120 may convert the data to formats requested by insurance companies and/or anonymize the data. The third party data provider may provide other data processing services for insurance companies as well. The third party data provider can be connected to (or accessed by) one or more insurers 116 and 125 through electronic communication networks 118 and 122, respectively.

Insurance company 125 can also connect directly to each of the states 108, 110, and 112 and their injury databases 102, 104, and 106 using its own data collection interface. Accordingly, insurance company 125 may elect to receive data from one or more of the states states 108, 110, and 112. Insurance company 125 can filter and/or anonymize the information itself. Insurance company 125 can also update its databases regularly, and pay any required fees. In addition to receive data directly from one or more states 108, 110, 112, insurance company 125 may additionally receive data from third party data provider 120. This would allow insurance company 125 to have a larger pool of data, i.e., data received directly from one or more states and data received from the third party data provider 120. The insurer 125 can also be connected to other insurers 116 through electronic communication network 144 to share fraud data. Also, insurance company 125 may also share fraud data with law enforcement 152.

Insurer 125 is shown with a firewall 124, for helping to secure the internal network and data. Insurer also includes a data collection interface 126 for interfacing with one or more third party data provider, and/or one or more states 108, 110, 112 directly, to obtain the injury data. The data collection interface 126 may also be able to interface with other data sources and collect data from these other data sources. Alternatively, insurer 125 may include additional data collection interfaces to interface and collect data from other data sources. This interface may be responsible for using the right electronic data interchange (EDI) formats. These interfaces may include a computer interface unit that includes various protocols that allow the systems of the insurer 125 to receive the data from each data source, and convert it to a format suitable for processing. The interface can also be used to filter out information before it is even processed. The collected data can be placed in database 132, where it can be accessed by data mining system 134 and modeling system 128. As described below, queries can be run against this collected data during the data mining process to extract relevant characteristics. These relevant characteristics can be use to improve an insurer's underwriting, actuarial, or marketing processes.

Data mining system 134 can be used to determine patterns or trends in the information and generate one or more reports, such as, prospect account report 136 and fraud report 140, or other reports or data analysis (not shown) discussed herein. The reports generated by the data mining system 134 may also be referred to as communications, and may take any faun, including reports, communications, alerts, spreadsheets, documentation, etc. These communications may take many forms, such as a fraud communication, a marketing communication, a sales communication, a pricing communication, a prospecting communication, a ratings communication, and a underwriting communication. Further, alerts generated by the data mining system 134 can be customized for the various departments within the organization (e.g., sales, underwriting, marketing, etc.). Reports, alerts, communications, etc. may be sent by any practical means, such as email, text/SMS message, social network, instant message, or any other form or format of communication. Data mining system 134 can be any one of known data mining systems, and can include customized scripts and software adapted to processing states worker's compensation injury data.

The modeling system 128 can be used to process data in database 132, or to process reports or data generated by data mining system 134. The modeling system 128 can use this data to improve models and estimates for prospecting, actuarial, or underwriting purposes. This data can be used for potential fraud detection, prospecting, pricing, underwriting, marketing, rating, sales, etc. Rating is a process that determines what rate a company should be charged for insurance. This reflects following rules and procedures that have typically been filed with the state in order to determine a rate to charge the client for various coverages, subject to deductibles and limits. Pricing is intended to be a more finely tuned process which reflects the particular nuances of the client that may not be adequately treated with the more generic rating plan. The pricing process allows the underwriter to consider even more particulars about a client and provide discounts or surcharges that help to make the price the client is charged more in keeping with the risk they represent, current conditions and other factors. By using the additional information provided by injury data (e.g., data from multiple insurers) the above processes can be more accurately performed. Data mining system 134 can also be accessed by a remote client or terminal 142. For example, this may be an internal business user of the insurer, or a customer service representative.

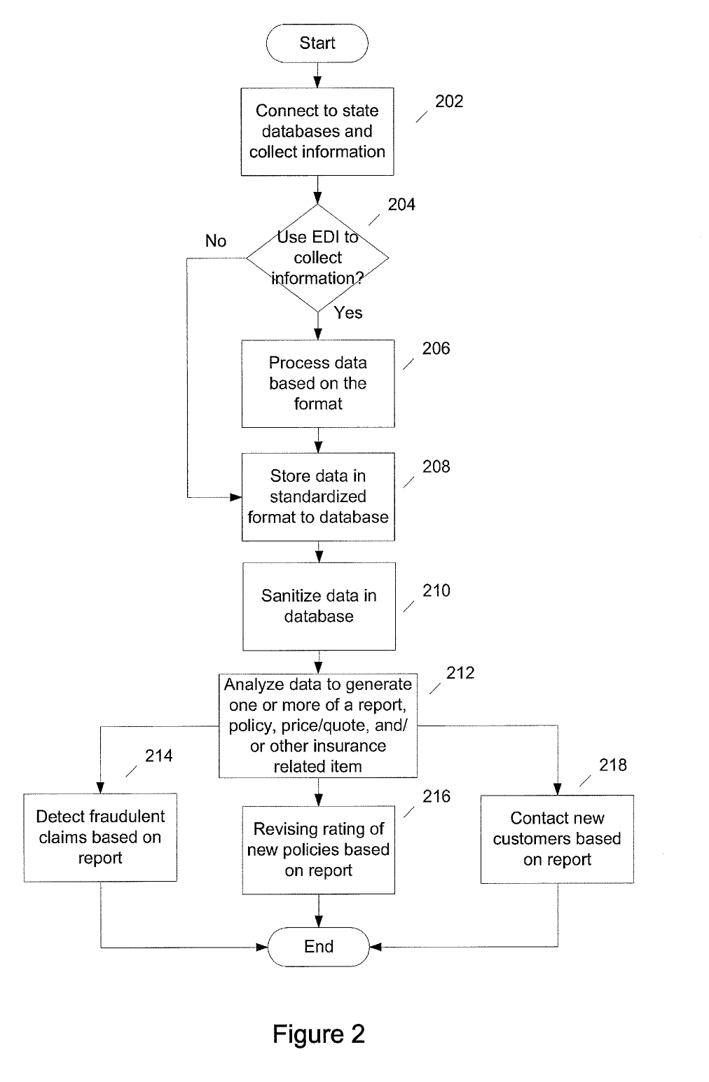

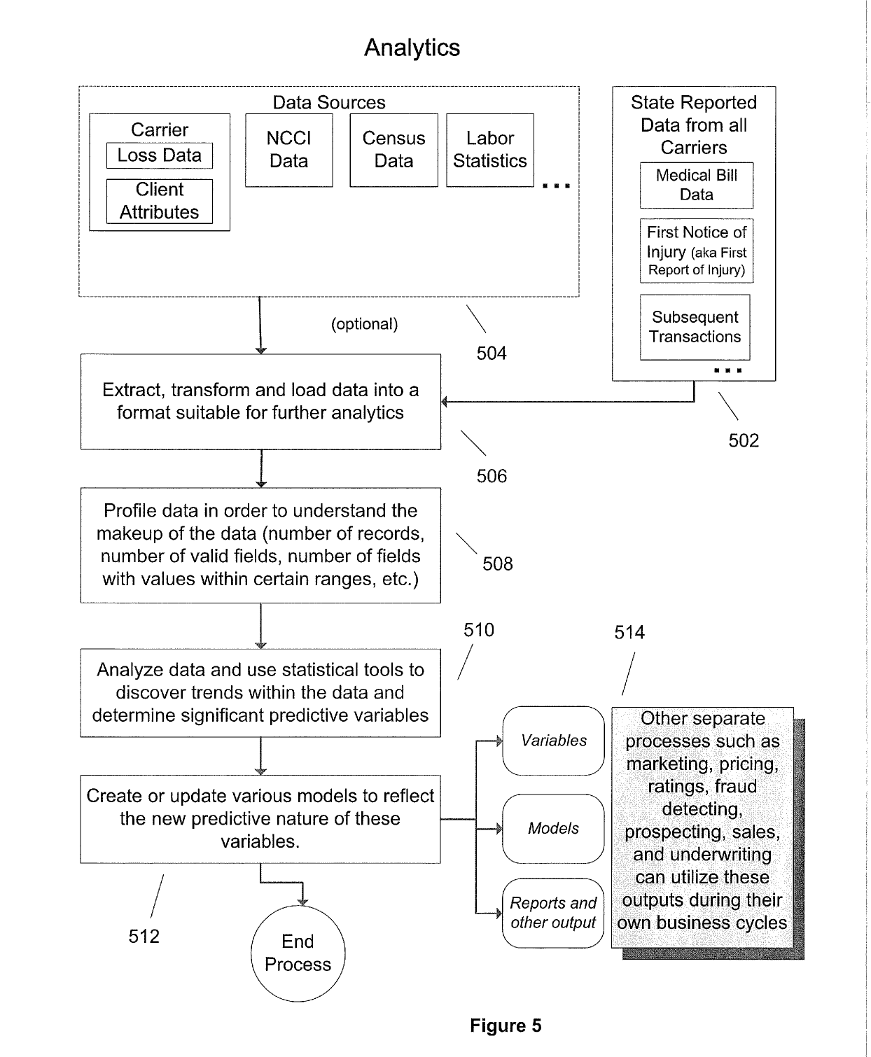

FIG. 2 is a flow diagram showing the overall process of one embodiment for processing state worker's compensation injury data. The process starts at block 202, where an insurer, or third party data provider, connects to a state information system to collect injury data. At block 204, it is determined if electronic data interchange (EDI) will be used to collect the information. At block 206, the data is processed. Because each state may provide different data, or data that is differently formatted, state specific data processing modules can be used. At block 208, this data can be stored in the single database 132 (FIG. 1) in a consistent format. At block 210 (or earlier if done by third party data provider) this data may be sanitized to make it anonymous and/or comply with any regulations. At block 212, the data is analyzed to generate at least one of a report, a policy, a price/quote, or other output for insurance such as models and model variables. FIG. 5 shows a flow chart of how the data may be analyzed in accordance with an embodiment of the invention. At blocks 214, 216, and 218, this data can be processed in one or more ways. This includes detecting fraudulent claims, revising ratings of policies, contacting new customers, or any of the other actions, analysis, or reports described herein.

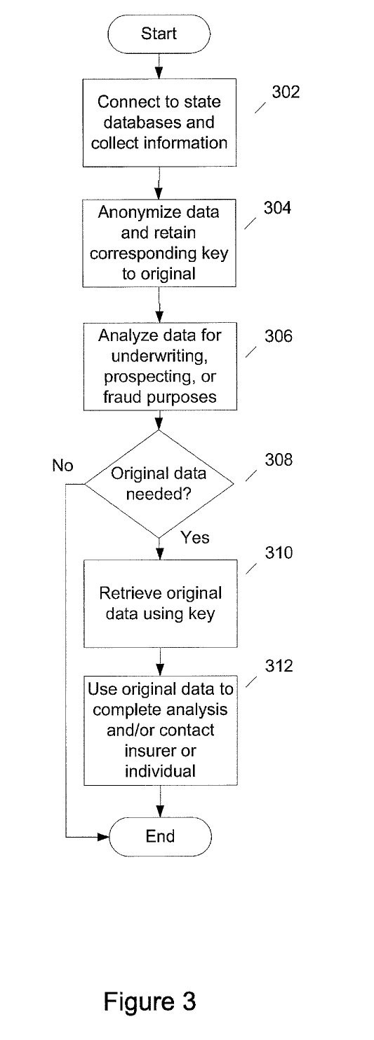

FIG. 3 is a flow diagram showing at least one embodiment of using anonymized data. At block 302, the insurance company 125 (or third party data provider 120) connects to states to collect injury data. At block 304, any of the fields, but particularly those that can be used to identify an individual (e.g. name or address) is anonymized. One or more fields of personal data may be anonymized by replacing it (or them) with a key, or hashed value. At block 306, This anonymized data can be analyzed and processed as usual. At block 308, if it is determined that the original data is needed, for example, to contact a particular individual, then at block 310 the key or hashed value can be used as a key or index to retrieve the original non-anonymized data. The same key or hashed value can be used to represent the same anonymized information. In this way, the analysis of information can easily determine when it is processing information for the same individual, or records that share information. At block 312, the original data is used to complete the analysis.

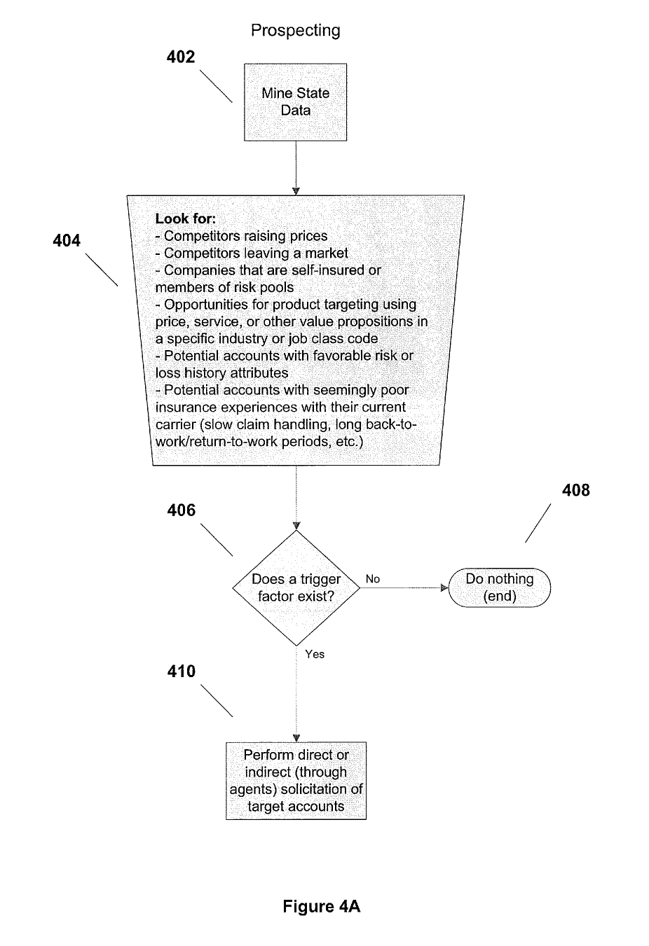

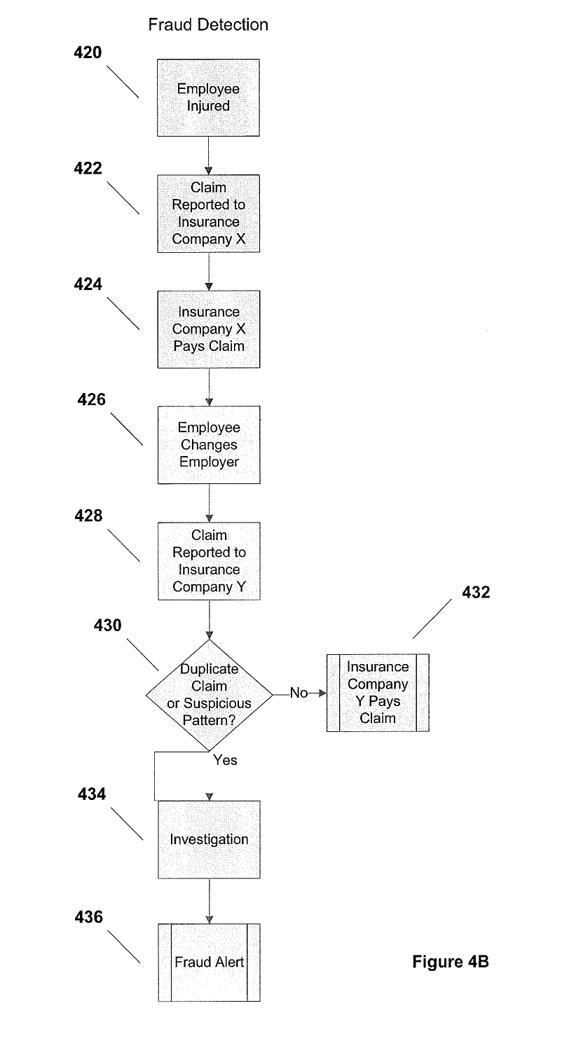

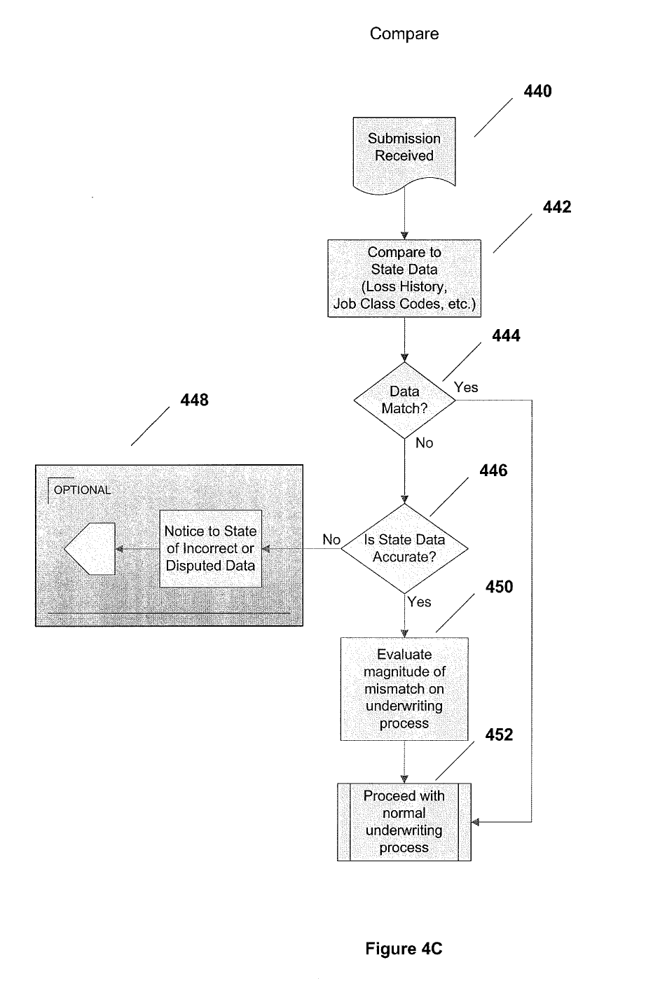

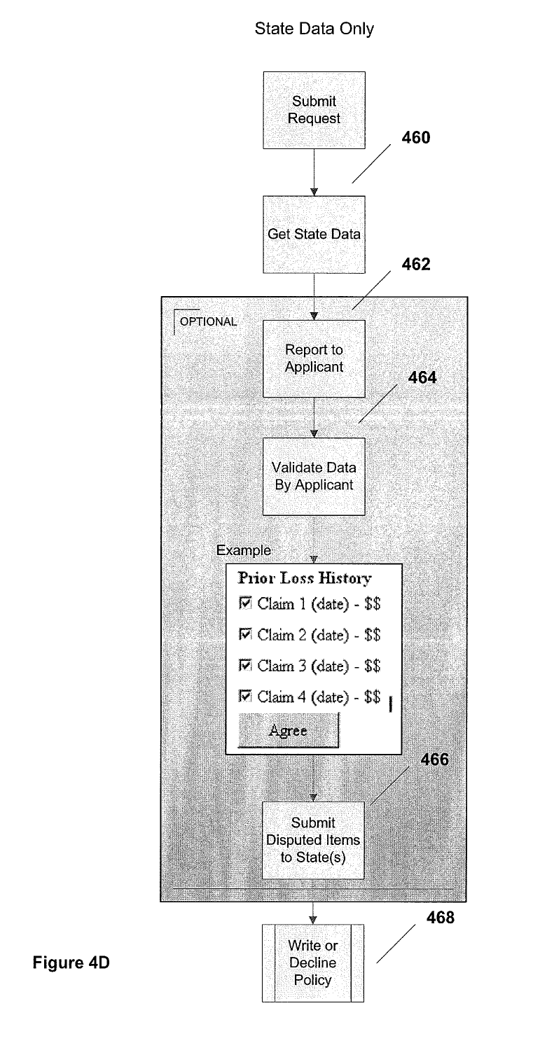

The worker's compensation data in the state databases 102 (FIG. 1) may have a format and fields such as that described in FIGS. 4-6 of the aforementioned Provisional patent application (Application Ser. No. 61/229,166), which is incorporated herein by reference. The data may include information submitted with a first notice of injured worker's compensation injury report; information submitted with a subsequent notice of injury worker's compensation injury report; and information submitted with a medical bill payment record worker's compensation injury report. This may include information such as referenced in IAIABC Claims Release 3 Standards (e.g. all or any of the fields with the data element names of, under “148 Data Elements”: Insurer FEIN, Employer FEIN, Employer Physical City, Employer Physical State, Employer Physical Postal Code, Industry Code, Date of Injury, Time of Injury, Accident Site Postal Code, Nature of Injury Code, Part of Body Injured Code, Cause of Injury Code, Initial Treatment Code, Data Employer Had Knowledge of the Injury, Date Claim Administrator had Knowledge of the Injury, Employee Date of Birth, Employee Gender, Employee Marital Status, Employee Number of Dependents, Initial Date Disability began, Employee Date of Death, Employment Status Code, Manual Classification Code, Employee Date of Hire, Wage, Wage Period Code, Number of Days worked per week, Initial Date Last Day Worked, Full Wages Paid for Date of Injury Indicator, Initial Return to Work Date; under “R21 Data Items”: Claim Administrator FEIN, Death Result of Injury Code, Type of Loss Code, Return to Work with Same Employer Indicator, Return to Work Code, Physical Restrictions Indicator, Insured FEIN, Insured Name, Insurer Name, Accident Premises Code, Accident Site County, Accident Site Location Narrative, Accident Site Organization Name, Accident Site City, Accident Site State Code, Accident Site Country Code, Employer Name, Employer UI number, Occupation Description, Claim Status Code, Claim Type Code, Accident/Injury Description Narrative, Full Denial Reason Code, Denial Reason Narrative, Managed Care Organization Code, Managed Care Organization Name, Managed Care Organization Identification Number; under “A49 Data Elements”: Insurer FEIN, Employee Number of Dependents, Pre-existing Disability Code, Initial Date Disability Began, Date of Maximum Medical Improvement, Current Return to Work Date, Employee Date of Death, Wage Period Code, Number of Days Worked Per Week, Date of Injury, Claim Status Code, Claim Type Code, Agreement to Compensate Code, Number of Permanent Impairments, Permanent Impairment Body Code, Permanent Impairment Percentage; under “R22 Data Elements”: Claim Administrator FEIN, Claim Administrator Name, Employee Date of Birth, Employee Marital Status Code, Employee Education Level, Employee Number of Entitled Exemptions, Anticipated Wage Loss Indicator, Reduced Benefit Amount Code, Death Result of Injury Code, Insured FEIN, Employer FEIN, Employer Physical Postal Code, Return to Work with Same Employer Indicator, Date Employer Had Knowledge of Date of Disability, Estimated Gross Weekly Amount Indicator, Current Date Last Day Worked, Current Date Disability Began, Initial Date Last Day Worked, Return to Work Type Code, Physical Restrictions Indicator, Suspension Effective Date, Full Denial Effective Date, Denial Rescission Date, Partial Denial Code, Calculated Weekly Compensation Amount, Wage Effective Date, Discontinued Fringe Benefits, Type of Loss Code, Employment Status Code, Permanent Impairment Minimum Payment Indicator, Initial Return to Work Date, Full Wages Paid for Date of Injury Indicator, Lump Sum Payment/Settlement Code, Employer Paid Salary in Lieu of Compensation Indicator, Average Wage, Initial Date of Lost Time, Award/Order Date, Number of Benefits, Number of Payments, Number of Other Benefits, Number of Benefit ACR, Number of Recoveries, Number of Reduced Earnings, Number of Concurrent Employers, Number of Full Denial Reason Codes, Number of Denial Reason Narratives, Number of Suspension Narratives, Benefit Type Code, Maintenance Type Code, Gross Weekly Amount, Gross Weekly Amount Effective Date, Net Weekly Amount, Net Weekly Amount Effective Date, Benefit Period Start Date, Benefit Period Through Date, Benefit Type Claim Weeks, Benefit Type Claim Days, Benefit Type Amount Paid, Benefit Payment Issue Date, Other Benefit Type Code, Other Benefit Amount, Benefit ACR Code, Benefit ACR Start Date, Benefit ACR End Date, Benefit ACR Weekly Amount, Recovery Code, Recovery Amount, Reduced Earnings Week Number, Actual Reduced Earnings, Deemed Reduced Earnings, and Medical Bill Standards (including fields: DN, Data Element Name, ASC X12N Format, CMS 1500, UB 04, 1A, Payer, HCP, JLB, SNDR, IAIABC Format), which were obtained from the International Association of Industrial Accident Boards and Commissions (IAIABC) Electronic Data Interchange (EDI) Implementation Guide for First, Subsequent, Acknowledgment Detail, & Trailer Records, Release 2, Feb. 28, 2001; the IAIABC EDI Implementation Guide for Claims, Release 3.0, Jan. 1, 2008; the IAIABC EDI Implementation Guide for Proof of Coverage, Release 2.1, Jun. 1, 2007; and the IAIABC EDI Implementation Guide for First, Subsequent, Acknowledgement Detail, Header, & Trailer Records, Release 1, Feb. 15, 2002, which are all incorporated by reference herein in their entirety. These are example fields, not all of these or others might be used.

More specifically the additional information, when used alone, or combined with other injury report, can be used to detect fraud. The type of procedures and health care provider used by an individual can be used to help determine if any fraudulent activity is occurring. The data can also be used for trending and to determine any pattern between employers, employees, and treating providers. This can also be used for prospecting purposes to determine which employers or employees are using preferred providers. These employers could be targeted for marketing purposes. The data may also be used for determining the ratings of existing and new policies, including actuarial calculations such as risk and underwriting calculations. Any of the embodiments of the invention described herein can benefit from the additional information provided by the medical bill payment reports, which can be combined with the notice of injury report data.

In some embodiments of the invention, the injury data is obtained from the states in an electronic format, either provided on a computer readable medium, or downloaded (or uploaded directly) through an electronic communication network (e.g. the Internet). Some of the injury data may be protected by HIPPA or other privacy laws or other data laws. Known techniques can be used to incorporate this data into a national database in accordance with HIPPA and other regulations. Alternatively, this data can be totally or partially excluded from the database or encrypted or coded to meet such regulations.

Embodiments of the invention describe systems and methods for utilizing state reported worker's compensation injury data (injury data) to improve an insurer's actuarial, marketing, claim processing, and underwriting activities. Further, the injury data can also be used in the reduction of fraudulent claims, more efficient prospecting for new business, expansion of an insurer's customer base and market penetration, improvements in pricing models, improvements in the information used during underwriting, and/or other uses.

By using state reported injury data, information is advantageously obtained about claims relevant to other insurers. In this way, not only can an insurer's own data be mined, but data relevant to other insurers can also be mined. In contrast, sources such as ISO limit the amount of data that can be requested so that mining is not possible or permitted.

Embodiments of the invention also include compiling injury data from each state into a national database containing information from some, many, or all of the US states. This data would then be available for more comprehensive data mining purposes and other information gathering purposes. This database would then be available to query and report against. In some states, information on worker's compensation claims may require a Freedom of Information Act (FOIA) request.

The information provided can include date of loss, type of injury, amount paid in non-medical, name and address of claimant, name of company, name of insurance company, age of worker, tenure of injured worker, length of injury, injured worker occupation, employer's class code(s), job class code, location of employee (e.g., postal code), etc. Other information that can be compiled include wage information, such as an injured workers wages. This can be compared to average wage data to determine how to improve marketing, actuarial, and underwriting activities. This can help when analyzing turnover and tenure, and their possible relation to injury rates and severity. Other information that can be compiled includes information about the employee, such as date of birth (including average age for the insurer etc), and gender.

As described above, embodiments of the invention can use the injury data for fraud detection. For example, by finding out if a claimant has made suspicious and/or numerous or frequent claims in the past. It could also be mined to look for patterns where the same name and identity is used in several claims (e.g. a fake ED is used by many people).

Embodiments of the invention can also use the injury data to prospect companies for purchasing worker's compensation insurance. By knowing a company's loss history ahead of time, companies where an insurer has a competitive advantage can be targeted.

Embodiments of the invention can also use the data when underwriting to determine a comprehensive worker's compensation loss history on a business. This can be used when providing a quote for insurance for example, for both new and existing policies. The injury data could be used to identify injury trends in certain types of occupations, worker ages, or worker tenures. It could also be useful for analyzing injury types and severities alongside days of missed work and which health care providers were treating the worker.

As discussed above, embodiments of the invention may also include using data from a third party data provider. This third party data provider can collect information from one or more of the states, and then provide it (for a fee or free) to a requesting insurer. This information could be provided electronically over the Internet, or through another electronic communication network or computer readable medium. The third party data provider could also sanitize or modify the data to make it anonymous and/or compatible with various regulations as discussed herein and/or make it compatible with insurer's formats and content, etc.

The third party data provider can also insure through periodic updates e.g. quarterly, monthly, daily or other periodic updates, that it has the most recent injury data. This most recent data could then be provided to any subscribing insurer. In other embodiments, the third party data provider could request information in response to a request from an insurer for certain injury data. In addition, the third party data provider could provide cached data to an insurer. For example, if an insurer requests injury data that it very recently requested, such as within the month, the data provider can send that stored information and not go back to the state. This can reduce the response time and/or fees to the insurer. In addition, the third party data provider could provide information recently requested by other insurers.

Embodiments of the invention can be used to create a list of prospective accounts (or potential insureds) for each carrier where an insurer would be competitive compared to a prospective account's current carrier. FIG. 4A shows a flow diagram of prospecting using the mined worker's compensation data in accordance with an embodiment of the invention. At block 402, the state worker's compensation data is mined. At block 404, various data within the mined worker's compensation data is analyzed. This may include, for example, a competitor's actions such as rates, entry or exiting a market, etc. Additionally, the analysis may include an analysis of companies that are self-insured or members of a risk pool. The prospecting analysis may also include identifying opportunities for product targeting using factors such as price, service, industries, job class codes, and for identifying potential accounts with favorable risk or loss attributes. The mined data may also allow for identification of potential accounts with poor experiences with their current carrier, including factors such as slow claim handling, long back-to-back work periods (also referred to as return-to-work periods), etc. Although certain criteria have been described with respect to prospecting, the invention is not limited to prospecting based only on the described criteria. Prospecting may be performed using any of the mined data that can provide insight into market trends, market potential, potential accounts, etc. These criteria can be used to determine a “trigger factor,” and as shown in FIG. 4A, the existence of a “trigger factor” may cause action to be taken by the insurance company. Trigger factors may include the identification of favorable factors that may dictate to an insurance company to target certain accounts. Based on the existence of a trigger factor in block 406, the company may do nothing (block 408) or perform direct or indirect solicitation of target accounts, as shown in block 410.

Embodiments of the invention can also be used to create a list of prospect accounts when a carrier is exiting a market or raising policy rates. The injury data can be mined by filtering injuries by the insurer name/FEIN and group into parent/umbrella companies. The filtered injury data could then be compared to available industry or legal data. Generated prospect accounts could then be grouped and aggregated with parent companies (where applicable) by looking at available industry data. Prospect accounts could also be grouped by multiple characteristics, including one or more of the carriers the prospect account was with, the industry they are in, and the account's size characteristics. The size characteristics could be obtained from business databases, such as Dunn & Bradstreet, which could also be used to classify the business. Prospect accounts can also be grouped by loss history. The address of the employer can also be geo-coded to obtain geographical information in relation to the prospect accounts.

Once the data has been mined for a given carrier or carriers, this method can be used by agents or brokers who wish to proactively solicit business that is currently with another carrier or carriers. After an insurer develops a list of target prospects, underwriters can run queries against the mined data to select accounts that are currently with a particular carrier. This could be refined based upon appetite, pricing relative to the other carriers, client risk characteristics, and market characteristics. This list might include data items such as loss frequency, average time to return to work, hours worked, market segment, NAICS codes (North American Industry Classification System), etc. Additional refining queries can also be run, and scores developed in data mining might be utilized. The insurer then provides the target prospects to its agents using at least one of the following methods: identify agents who are likely to be interested in the given subset of clients (e.g., agents who are located near the business, agents who specialize in the given industry, etc.), or agents for which the target prospect would be key prospects. Agents can also be provided with an interface into a query tool which they can use to create prospects lists (this tool may be based upon a subset of the mined data which are the target prospects), or the agents can be notified of target prospect status when they create a submission using an insurer's or third-party automated quoting system. The rest of an insurer's quoting and issuance process can proceed normally.

Embodiments of the invention can also be used to focus on self-insured members or on other weakness in the market (risk pools that may have weakened financial positions). These members may be persuaded to buy commercial coverage. The data mining process includes creating groups of injuries that are marked with a “self-insured” indicator to identify a self-insured industry group, or self-insured employers. It also includes creating an “administration quality” score (as compared to industry averages) by looking at data such as, total number of injured days out of work, or number of days out of work compared to the nature of an injury code. Once the data has been mined, research about the financials of self-insureds and self-insured groups can be done, for example, identifying those that may be closer to insolvency. A list of prospects can be generated as described herein.

Embodiments of the invention can also be used to determine an account's loss history, which can be used by an insurer to expand their customer base and increase market penetration. The data mining process includes creating lead lists of the best risks and creating tables of losses for each employer by Federal Employer Identification Number (FEIN) or Tax ID number. The processing also includes grouping employers by industry code and scoring them on metrics such as injuries per employee, injuries per dollar of wages, and injuries per employee-hour worked. The process of how this data can be utilized is described herein.

Embodiments of the invention also include determining employers vs. health care providers, and finding patterns of employers that tend to use preferred or designated health care providers. This can be used to refine an insurer's targeted marketing efforts. The data mining process includes creating tables of injuries by employer, and grouping by health care provider who treated the injury.

The process for utilizing the data includes running queries to find businesses with more favorable provider usage. The process may also include using this information to perform targeted marketing, or combining this information with at least one other criteria to target accounts for prospecting. The rest of the process is as described herein.

Embodiments of the invention also include bringing predictive modeling to prospecting. This can be used to perform faster, easier, and earlier risk pre-qualification. This process includes running queries against collected data to find prospects that have scores or other indicators above a certain threshold. These prospects can be targeted for marketing or pre-qualification. The rest of the process is as described herein.

Embodiments of the invention can also be used to analyze prior claims of members. Losses can also be validated, and using this information, an insurer can assess truthfulness and completeness of data in submissions (use this for validating underwriting and claims made). The data mining can be used to create loss history tables organized by employer FEIN, regardless of the member's insurer at the time. The insurer can also improve underwriting and pricing accuracy, as well as reduce fraud.

The process of using the mined data for validating loss histories includes an insurer receiving a submission for a new business worker's compensation policy, receiving a loss history with the submission, performing a loss history query against the mined data, and comparing the result of the submission loss history and mined data. If the loss histories match to a high degree, this is one indication of the integrity of the submission. If the loss histories are materially different, this calls the integrity of the submission into question. This is especially true if the omission regards a particularly large or important loss. The insurer can use a validation step at this point. The result of the comparison is then weighed in the underwriting decision. In addition to the above comparison, if other questionable data is found, this may help the underwriter to know to exercise caution.

Embodiments of the invention can also be used to validate unreported or misreported class codes and occupations. The data can be mined by creating loss history tables by employer FEIN, and organized by employment class code. The data can then be combined with data from an account's application for insurance. Losses can be identified where the nature of the injury code or the cause of injury code does not appear on account's application. This can lead to improved underwriting accuracy and reduction of misinformation or potential fraud.

The mined data can be used to validate prior claim's class codes. The process can include an insurer receiving a submission for a new business worker's compensation policy. The insurer can receive a loss history with the submission, which it can use to perform a loss history query against the mined data. The insurer can then derive a list of class codes and occupations from each history. The two lists are then compared, if they match to a high degree, this is one indication of the integrity of the submission. If they are materially different, this calls the integrity of the submission into question. This is especially true if the omission regards a particularly expensive class code or dangerous occupation. A validation process can be done at this point. The results of the comparison can be weighed in the underwriting decision. If other questionable data is found, this may help the underwriter to know to exercise caution.

Embodiments of the invention can also be used to review individual claimant history. This can supplement data from other sources such as the Insurance Services Office (ISO) and help to detect potential fraud and/or apportion claims. The data mining includes sorting injury reports by employee identifier (SSN or something similarly unique). Using unique employee identifiers, the data mining can generate reports focused on specific individuals. These reports can include nationwide information listing an individual's injury history, including types of injuries, frequency of injuries, duration of injuries, severity of the injuries, etc. Having the ability to see a claimant's history can help to identify potential fraud associated with a particular individual. The data mining also includes building reports based on individual employee injury frequency and severity. Additionally, the data mining may also include determining prior claims' class codes vs. employee occupation. This can be used to determine workers performing unreported or misreported tasks, which can be used by an insurer to improve underwriting accuracy and reduce fraud. The data mining process includes organizing injury reports by employment class code, nature of injury, and/or cause of injury code. The process may also include grouping common injuries among workers in similar employment class codes. The process may also include identifying outliers and using them to determine if an employer is using workers to perform tasks that are not represented by the employer's reported class codes and occupations. Accordingly, embodiments of the present invention can be used to detect potential fraud, as well as help an insurer improve subrogation and claim reserving accuracy.

The process can be used to identify possible fraudulent claimants. The process includes executing queries against mined data to identify any claimants that have a high likelihood of having made fraudulent claims, based upon a score or other indicator derived in data mining. The process may also include creating a file of claimants in a high risk category in the claim handling or policy administrative system, and for each new claim, comparing the information to the high risk claimants to determine possible fraudulent activity. The insurer can then perform more due diligence on these files to ensure that they are legitimate claims.

FIG. 4B shows a flow diagram for detecting potential fraud using mined worker's compensation data in accordance with an embodiment of the invention. In blocks s 420-424, an employee is paid a worker's compensation claim by an insurance company. In block 426, the employee may change jobs, and file another claim with another insurance company in block 428. In block 430, the insurance company may use the mined data to detect suspicious activity or a possible duplicate claim. Based on whether the claim appears to be suspicious, the insurance company may pay the claim (block 432) if it is not deemed to be suspicious, or initiate an investigation, as shown in block 434, and may issue a fraud alert as shown in block 436. Advantageously, the present invention is able to detect a potential fraud by collecting worker's compensation claim data from at least one state database. Other methods of detecting fraud by employers or medical providers would also be possible through similar techniques.

As noted above, embodiments of the invention can also be used to review individual claimant history, which can be used to enhance the ability of an insurer to apportion claims. This can help an insurer improve subrogation and claim reserving accuracy. The data mining process includes sorting injury reports by employee identifier (SSN or something similarly unique). The process may also include building reports based on individual employee injury frequency and severity.

The process for using the mined data includes processing a claim normally up to the point where the injuries have been identified and documented, and a course of treatment recommended. At this point, the claimant's claim history based on the mined data may be reviewed. If there are injuries in the claim history that might exacerbate or in some way impact the patient's current situation, then the claim may be marked for possible apportionment. If so marked, then the normal claim recovery process may be followed.

Embodiments of the invention also include determining losses by industry and class code across an entire state. By using a larger data set based on mined data, including information from all insurance carriers, trending analysis within environments for each state can be determined, including creating “early warning” opportunities. The data mining process includes sorting injury reports by employer, including scoring injuries on severity, matching employer industry codes, creating aggregate views, and creating frequency metrics (e.g. injuries per dollar of wage, or per employee for a time period). The data mining process can also include sorting injury reports by the state in which they occurred, including scoring the injuries on severity, creating aggregate views, and creating frequency metrics (e.g. injuries per dollar of wage, or per employee for a time period). This data mining process can improve pricing analysis, underwriting guidelines, and focus product and marketing efforts. The data mining results in new knowledge regarding safety in various industries.

Actuaries can use this information to analyze the adequacy of an insurer's rates in various industries. In industries where an insurer has low penetration, actuaries can, on a case by case basis, lower rates. For example, if an insurer wishes to grow in that sector, rates can be lowered to be more attractive to the market, subject to any regulatory guidelines. Alternatively, rates can be raised to avoid adverse selection by carriers that write more in that sector, and presumably know more. In industries where the insurer has a large market share, it helps to further refine prices. Underwriters can use this data to refine eligibility requirements and risk appetite guidelines. If the broader industry data within a state is considerably different than the insurer's own experience, and if the rate cannot make up the difference (i.e., the insurer is already priced above or below the market) or if the insurer is not comfortable with the business and rate, then the insurer can modify eligibility or risk appetite accordingly.

Embodiments of the invention can also be used to determine the age of claimants vs. claim severity. Based on this, the mean/median age of workers in an industry, class codes can be compared to an individual account. The data mining process includes relating the age of a worker for a class, company, and industry, and/or for a class within a company or industry. The statistics for companies, groups of companies, or an entire industry or sector are then related to the severity and/or frequency of worker's compensation losses for those groups. A determination may be made as to whether these statistics are predictive of severity and/or frequency of losses. The process can be used to improve pricing accuracy.

The process for utilizing the data may include building new statistics, predictive models and/or pricing models. From the mined data, an underwriter may collect an employee's age, or average age of employee by class, during the quoting process. The pricing model and ultimate price will reflect new data.

Embodiments of the invention can also used to determine the average tenure of an injured worker. This can be built into the pricing model where less experience may equal more injury, for example. This can be used to improve underwriting. The data mining process includes segmenting workers by the type of labor they perform, and within each segment, creating rankings by injury level. Workers can also be from each respective type of labor, to find correlation between injury frequency and injury severity as compared to tenure in the profession. The data can be used to improve underwriting as described herein.

Embodiments of the invention can also be used to geo-code addresses such that a better price-zone model can be created and pricing accuracy can be improved. The data mining process may include feeding employer addresses into a geo-coder, and grouping geo-coded addresses by proximity to each other to be rated as a class.

Embodiments of the invention also include determining the average wage by class code of injured workers. This can be used to benchmark risks' wage relativity to average class code wage, thereby improving pricing accuracy. The data mining process includes creating tables of injured workers' wages as well as the worker's employment class code, and if possible correlating this data to total lost cost of each injury. This data can be used to improve pricing accuracy as described herein.

Embodiments of the invention also include determining class code vs. occupation description. This can be used by an insurer to refine predictive modeling to achieve pricing and selection advantages. The data mining process includes discovering the dominant occupation within each code, and determining injury frequency rates. The process includes creating tables of industry class codes, the employment codes, and/or occupation descriptions of injured workers in each state. The process may also include scoring accounts based on how similar or different their occupational makeup appears to be compared to their peers (and whether that seems to make them more prone to losses). The process of utilizing this data is described herein.

Embodiments of the invention also include comparing a class code vs. a worker's age. This can be used to improve pricing accuracy. By determining which class codes are getting younger, and which may be indicative of future losses, pricing accuracy can be improved. The data mining process includes creating tables of injuries by employment class code and/or occupation description, and grouping them by the age of the injured worker. The process may also include determining if there is correlation between a worker's age, and injury severity and frequency for each employment class code or description. The process for utilizing this data is described herein.

FIGS. 4C and 4D show flow charts using the mined worker's compensation data for rating policies according to an embodiment of the invention. As shown in FIG. 4C, when an application for a policy is received in block 440, the insurance company may compare this information to the mined state data in block 442 and determines whether the data matches in block 444. If the data does not match, the company may verify whether the data received from the states is accurate (block 446), and optionally share the mismatched data as shown in block 448. Otherwise, the company may assess the importance of the inconsistencies (block 450) and proceed with the underwriting process, as shown in block 452. As shown in FIG. 4D, the insurance company may obtain the mined state data (block 460), and optionally share the obtained information with the applicant, as shown in block 462. The applicant may validate the data (block 464), and the company may possibly submit any disputed items to the states (block 466), and possibly continue to issue the policy (block 468).

Embodiments of the invention can also be used to determine the total amount of losses in a state to better measure an insurer's market share vs. competitors, providing insights into how an insurer's competitors view the marketplace. The data mining can be used to determine the size of competitors' market share, assuming that they have similar loss rates to the insurer. This data is not available in such discreet categories from other sources. The data mining process includes creating tables of losses sorted by industry codes and the state that the employers' addresses are located in. The process may also include correlating the data with internal loss rates for each industry, and extrapolating the size of competitors' books of business in each industry.

The mined data can be used to examine trends in the worker's compensation marketplace, and especially how key competitors in each state are growing or shrinking in certain regions, industry classes, etc. For example, reports may be run against the mined data to examine market share relativities in the worker's compensation marketplace for a given state or region. This process also includes using this intelligence to determine how an insurer's competitors are moving in the market. The process may also include investigating and explaining anomalies or unexpected results. This intelligence can be used to determine how competitors are viewing the market. Based on the analysis and data, marketing strategies can be designed using this new intelligence.

FIG. 5 shows an exemplary flow diagram of at least one embodiment of analytics that may be applied to the mined data. Block 502 represents receipt of the state injury data that is received from the states. This may include data that is received directly from one or more states, possibly via EDI, and data that is received from third party data providers. The data received from the states may include medical bill data, first notice of injury (also referred to as first report of injury) data, subsequent transaction data, etc. Optionally, this data may be combined with other data sources (shown at 504) such as the carrier loss data and client attributes, National Council on Compensation Insurance (NCCI) data, Census data, labor statistics data, etc. In block 506, the data is extracted, transformed, and converted into a format suitable for performing analytics. In an alternative embodiment, an insurance company may receive the data in this form from third party data providers, or from both third party data providers and from one or more states. In block 508, the data is profiled to ascertain the make-up of the data. In block 510, the data is analyzed, including the use of statistical tools to discover trends within the data and to determine predictive variables. In block 512, the analyzed data is used to create or update various models. For example, these models and predictive variables may be used for underwriting, fraud detection, prospecting, claims processing analysis, marketing, etc., as indicated by 514.

Embodiments of the invention can also be used to determine the distribution of carriers in state vs. losses. This can be used to find industries with low/nonexistent penetration by the insurer and help the insurer decide whether they should expand/enter the market. This can be used to increase an insurer's customer base and market penetration. The data mining process includes creating tables of injuries by insurer name/FEIN and grouping into parent/umbrella companies by comparing to available industry or legal data. The data mining process also includes sorting each table by industry class code to determine where the insurer table has little to no loss data. The data mining process also includes filtering out other carriers' losses in those industries to see if the insurer should try to expand.

Embodiments of the invention also include determining the days of work lost by injury vs. insurance carrier. This can be used to determine if the insurer gets injured workers back on the job sooner than other insurance carriers. Therefore, loss costs can be used to demonstrate the added value of the insurer's claim management process. The data mining process includes creating tables of injuries by insurer name/FEIN and grouping them into parent/umbrella companies by comparing to available industry or legal data. The data mining process also includes sorting by injury type and/or employment class code. This process also includes calculating average return to work time per injury for each insurance carrier.

The process of utilizing the mined data includes creating comparison reports of actual back-to-work (return-to-work) statistics. Reports can be by state, region, and/or industry, and may also be based on the wages of the employee, etc. The process may also include providing feedback to operations for continuous improvement of processes. A dollar value can be assigned to the amount of delay. The process includes creating marketing materials demonstrating an insurer's superiority.

Embodiments of the invention also include determining First Notice of Injury (FNOI—First report of injury) reports compared over time. This can be used to see how each carrier/state handles their reports (promptness, accuracy, level of detail). The data mining process includes creating tables of injuries by insurer name/FEIN and grouping into parent/umbrella companies by comparing to available industry or legal data. The process may also include creating tables of injuries by the state the data is reported to. The process includes sorting injuries in each set of tables by various criteria, including, but not limited to, date of injury vs. date reported, number of completed fields in the report, whether or not a follow-up report was filed, and which fields in the report were completed. This can allow an insurer to promote their superior claim processing in marketing materials.

Embodiments of the invention also include determining the duration of an injury over time. This can be used to determine trends for various types of injuries regarding recovery time, and can improve pricing and accuracy. The data mining process includes creating tables of losses by nature of injury code and/or by cause of injury code. The process may also include sorting by number of days out of work to determine recovery time by injury type. The data can be utilized using the process described herein.

Embodiments of the invention can also be used to assess claim processing. For example, the mined data can compare the date of injury vs. the date it was reported. This reporting lag may be a reflection of the quality of the company's claim administration program and can help an insurer improve underwriting accuracy. The data mining process includes determining the difference between the Date of Injury field value and the Date Reported to Employer. It also includes determining the difference between the Date of Injury field value and the Date Reported to Claim Administrator. The data can be used to determine what the key performance indicators (KPI) are of a “best practice” situation for each type of injury. The data mining can also include scoring accounts based on percentage of FNOI reports that fall outside best practice guidelines.

During normal typical quote creation process, an underwriter may obtain the mined data regarding the average reporting lag of the account. This can be done in several ways, a predefined query can be run against the collected data in a database (e.g. a state by state one, or national one) taking the account name as input. Alternatively, an ad hoc query can be run against the data, or an automated step can be added to the quote submission process, where this value is obtained from collected data and is used to augment the quote submission data. The underwriter, or underwriting rule-set, uses this data independently, or combined with other data, to help make an underwriting decision.

Embodiments of the invention also include comparing the treating health care providers (or other health care providers) vs. injuries. This can be used to identify which local health care providers are commonly used for each type of injury. This worker's compensation data can then be combined with other state data on the health care provider (registrations, malpractice complaints, etc.). The data mining process includes creating tables of injuries by nature of the injury code, and grouping by the health care provider who treated the injury. The process of utilizing the data includes developing queries for the mined data which may use zip code and/or injury codes to create lists of health care providers that have large experience and favorable patient outcomes. The process may also include, during normal claim processing, suggesting use of certain health care providers by patients. This could be done proactively, or as a result of a claimant asking for advice.

Embodiments of the invention also include determining the treating health care provider vs. time out of work. This can be used to identify which health care providers have a better record in terms of getting an employee back to work sooner. This can reduce costs for an insurer, and therefore improve pricing. The data mining process includes creating tables of injuries by nature of the injury code, and grouping by the health care provider who treated the injury. The process may also include sorting by the number of employee missed work days.

The process for utilizing the mined data includes processing a claim as in the usual manner. After processing the claim, using the worker's compensation injury data, preferred health care providers can be recommended. This can be done when a physician needs to be chosen by the injured worker, and they ask for recommendations, if it is permitted for the insurer to make a recommendation for a physician without the worker first requesting it, when a physician is assigned (where applicable and within state regulations), or when a physician has already been chosen by the worker, but an alternate (and preferred) name is offered for consideration. The use of preferred provider can help lower costs for an insurer. If an injured worker asks for physician recommendations, then a preferred health care provider can be recommended, if possible. If an injured worker has chosen a physician, the process may include checking their back-to-work (return-to-work) statistics, and offering information to the injured worker accordingly.

It is to be understood that the embodiment(s) described above are not limited in its application to the details of construction and to the arrangements of the components set forth in the above description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

For example, the specific sequence of the above described process may be altered so that certain processes are conducted in parallel or independent, with other processes, to the extent that the processes are not dependent upon each other. Thus, the specific order of steps described herein are not to be considered implying a specific sequence of steps to perforin the above described process. Other alterations or modifications of the above processes are also contemplated.

We claim:

1. A worker compensation data mining computer system, comprising:
a data collection computer interface electronically receiving worker's compensation data stored by at least one of a third party data provider and at least one state injury computer database administered by a respective state via a communications network;
a second data collection interface electronically receiving additional worker's compensation data;
a storage database storing the worker's compensation data received by said data collection computer interface;
a data mining computer processing unit analyzing at least one of the worker's compensation data from the at least one state injury computer database and the additional worker's compensation data to determine trends in the worker's compensation data and, responsive to said analyzing, to generate at least one a fraud communication, a model, a predictive variable, a marketing communication, a sales communication, a pricing communication, a prospecting communication, a ratings communication, and an underwriting communication; and
a modeling computer processing unit, analyzing at least one of the worker's compensation data and the additional worker's compensation data and at least one of underwriting models, sales models, pricing models, ratings models, marketing models, fraud models, and prospecting models, and responsive to said analyzing determining whether to modify the at least one of the underwriting models, the marketing models, the sales models, the pricing models, the ratings models, the marketing models, the fraud models, and the prospecting models.

2. The worker compensation data mining computer system as recited in claim 1, wherein the data collection computer interface receives the worker's compensation data from a third party data provider that collects the worker's compensation data from the at least one state injury computer database.

3. The worker compensation data mining computer system as recited in claim 1, further comprising a computer interface unit, including a plurality of interface protocols to receive the worker's compensation data in a plurality of data formats stored by the at least one state injury computer database, and to convert the plurality of data formats into a substantially same data format for processing by said data mining computer processing unit.

4. A worker compensation data mining computer system, comprising:
a data collection computer interface receiving worker's compensation data stored by at least one state injury computer database administered by a respective state via a communications network;
a storage database storing the worker's compensation data received by said data collection computer interface; and
a data mining computer processing unit analyzing the worker's compensation data from the at least one state injury computer database to determine trends in the worker's compensation data and, responsive to said analyzing, to generate at least one of a fraud communication, a marketing communication, a model, an updated model, a predictive variable, a prospecting communication, a ratings communication, a sales communication, a pricing communication, and an underwriting communication.

5. The worker compensation data mining computer system as recited in claim 4, wherein the data collection computer interface receives the worker's compensation data from a third party data provider that collects the worker's compensation data from the at least one state injury database.

6. The worker compensation data mining computer system as recited in claim 4, wherein the data mining computer processing unit sanitizes the worker's compensation data by at least one of formatting and making the worker's compensation data anonymous.

7. The worker compensation data mining computer system as recited in claim 4, wherein the data collection computer interface electronically receives the worker's compensation data directly from the at least one state injury database and the data mining computer processing unit analyzes worker's compensation data from the at least one state injury database.

8. The worker compensation data mining computer system as recited in claim 5, wherein the data collection computer interface electronically receives additional worker's compensation data directly from the at least one state injury database and the data mining computer processing unit analyzes the worker's compensation data and the additional worker's compensation data from the at least one state injury database and the third party data provider.

9. The worker compensation data mining computer system as recited in claim 4, further comprising a modeling computer processing unit, receiving the worker's compensation data from the at least one state injury computer database, analyzing at least one of underwriting models, sales models, pricing models, ratings models, fraud models, prospecting models, and marketing models, and responsive to said analyzing determining whether to modify the at least one of the underwriting models, sales models, pricing models, ratings models, fraud models, prospecting models, and the marketing models.

10. The worker compensation data mining computer system as recited in claim 9, wherein said modeling computer processing unit modifies the at least one of the underwriting models, sales models, pricing models, ratings models, fraud models, prospecting models, and the marketing models responsive to said determining whether to modify the at least one of the underwriting models, sales models, pricing models, ratings models, fraud models, prospecting models, and the marketing models.

11. The worker compensation data mining computer system as recited in claim 4, further comprising a computer interface unit, including a plurality of interface protocols to receive the worker's compensation data in a plurality of data formats stored by the at least one state injury computer database, and to convert the plurality of data formats into a substantially same data format for processing by said data mining computer processing unit.

12. The worker compensation data mining computer system as recited in claim 4, further comprising a computer interface unit electronically transmitting the fraud communication to insurance computer systems of other insurance companies.

13. The worker compensation data mining computer system as recited in claim 4, wherein the worker's compensation data from the at least one state injury computer database is combined with additional data comprising at least one of carrier loss data, carrier client attribute data, National Council on Compensation Insurance (NCCI) data, Census data, and labor statistics data, and the analyzing performed by the data mining computer processing unit is performed on the combined data.

14. The worker compensation data mining computer system as recited in claim 4, further comprising an underwriting computer system receiving from said data mining computer processing unit underwriting information comprising at least one of the model, the updated model, the predictive variable, the ratings communication, the sales communication, the pricing communication, and the underwriting communication, and said underwriting computer system executing an underwriting process responsive to the underwriting information.

15. The worker compensation data mining computer system as recited in claim 4, wherein the at least one state injury computer database includes a plurality of state injury computer databases.

16. A computer implemented method for electronically mining worker compensation data, the method comprising:
electronically receiving worker's compensation data stored by at least one of state injury computer database administered by a respective state via a communications network;
storing the received worker's compensation data in an electronic database;
analyzing, by a computer, the worker's compensation data from the at least one state injury computer database to determine trends in the worker's compensation data; and
generating, by the computer, at least one of a model, a predictive variable, an updated model, a fraud communication, a marketing communication, a prospecting communication, a ratings communication, a sales communication, a pricing communication, and an underwriting communication based on the analysis of the worker's compensation data.

17. The method for electronically mining worker compensation data as recited in claim 16, further comprising receiving the worker's compensation data from a third party data provider computer system.

18. The method for electronically mining worker compensation data as recited in claim 16, further comprising sanitizing the worker's compensation data by at least one of formatting the worker's compensation data and anonymizing the worker's compensation data.

19. The method for electronically mining worker compensation data as recited in claim 16, further comprising modeling based on the worker's compensation data and at least one of underwriting models, sales models, pricing models, ratings models, fraud models, prospecting models, and marketing models.

20. The method for electronically mining worker compensation data as recited in claim 16, further comprising electronically transmitting the fraud communication, to a computer system administered by another insurance company.

21. The method for electronically mining worker compensation data as recited in claim 16, further comprising:
electronically receiving at least one of additional worker's compensation data and analyzed worker's compensation data;
analyzing the worker's compensation data from the at least one state injury database and the additional worker's compensation data; and
generating, by the computer, at least one of the model, the predictive variable, the updated model, the fraud communication, the marketing communication, the prospecting communication, the ratings communication, the sales communication, the pricing communication, and the underwriting communication based on the analysis of the worker's compensation data.

22. The method for electronically mining worker compensation data as recited in claim 16, further comprising executing an underwriting process by an underwriting computer system using at least one of the generated model, the ratings communication, the sales communication, the pricing communication, the fraud communication, the underwriting communication, and the predictive variable.

23. The method for electronically mining worker compensation data as recited in claim 16, wherein the generated model includes a modified version of an existing model, and wherein said method further comprises generating, by the computer, the modified version of the existing model.

24. The method for electronically mining worker compensation data as recited in claim 16, further comprising combining the received worker's compensation data stored by the at least one state injury computer database administered by the respective state with additional data and wherein the analyzing is of the combined data.

25. The method for electronically mining worker compensation data as recited in claim 24, wherein the additional data includes at least one of carrier loss data, carrier client attribute data, National Council on Compensation Insurance (NCCI) data, Census data, and labor statistics data.

26. A computer implemented method for electronically issuing an insurance policy, the method comprising:
electronically receiving worker's compensation data stored by at least one of state injury computer database administered by a respective state via a communications network;
storing the received worker's compensation data in an electronic database;
analyzing, by a computer, the worker's compensation data from the at least one state injury computer database to determine patterns or trends in the worker's compensation data;
generating, by the computer, at least one of a model, a predictive variable, an updated model, a fraud communication, a marketing communication, a prospecting communication, a ratings communication, a sales communication, a pricing communication, and an underwriting communication based on the analysis of the worker's compensation data; and
issuing the insurance policy based on at least one of the generated model, predictive variable, updated model, fraud communication, marketing communication, prospecting communication, ratings communication, sales communication, pricing communication, and underwriting communication.

27. The method for electronically issuing an insurance policy as recited in claim 26, further comprising combining the received worker's compensation data stored by the at least one state injury computer database administered by the respective state with additional data and wherein the analyzing is of the combined data.

28. A computer implemented method for electronically pricing an insurance policy, the method comprising:
electronically receiving worker's compensation data stored by at least one of state injury computer database administered by a respective state via a communications network;
storing the received worker's compensation data in an electronic database;
analyzing, by a computer, the worker's compensation data from the at least one state injury computer database to determine patterns or trends in the worker's compensation data;
generating, by the computer, at least one of a model, a predictive variable, an updated model, a fraud communication, a marketing communication, a prospecting communication, a ratings communication, a sales communication, a pricing communication, and an underwriting communication based on the analysis of the worker's compensation data; and
pricing the insurance policy based on at least one of the generated model, predictive variable, updated model, fraud communication, marketing communication, prospecting communication, ratings communication, sales communication, pricing communication, and underwriting communication.

29. The method for electronically pricing an insurance policy as recited in claim 28, further comprising combining the received worker's compensation data stored by the at least one state injury computer database administered by the respective state with additional data and wherein the analyzing is of the combined data.

30. A worker compensation data mining computer system, comprising:
a data collection computer interface receiving worker's compensation data stored by a plurality of state injury computer databases administered by a plurality of states via a communications network;
a storage database storing the worker's compensation data received by said data collection computer interface; and
a data mining computer processing unit analyzing the worker's compensation data from the plurality of state injury computer databases to determine trends in the worker's compensation data and, responsive to said analyzing, to generate at least one of a fraud communication, a marketing communication, a model, an updated model, a predictive variable, a prospecting communication, a ratings communication, a sales communication, a pricing communication, and an underwriting communication.

31. The worker compensation data mining computer system as recited in claim 30, wherein the data collection computer interface receives the worker's compensation data from a third party data provider that collects the worker's compensation data from the plurality of state injury databases.

32. The worker compensation data mining computer system as recited in claim 30, further comprising a computer interface unit, including a plurality of interface protocols to receive the worker's compensation data in a plurality of data formats stored by the plurality of state injury computer databases, and to convert the plurality of data formats into a substantially same data format for processing by said data mining computer processing unit.

33. The worker compensation data mining computer system as recited in claim 30, wherein the worker's compensation data from the plurality of state injury computer databases is combined with additional data comprising at least one of carrier loss data, carrier client attribute data, National Council on Compensation Insurance (NCCI) data, Census data, and labor statistics data, and the analyzing performed by the data mining computer processing unit is performed on the combined data.

34. The worker compensation data mining computer system as recited in claim 30, further comprising an underwriting computer system receiving from said data mining computer processing unit underwriting information comprising at least one of the model, the updated model, the predictive variable, the ratings communication, the sales communication, the pricing communication, and the underwriting communication, and said underwriting computer system executing an underwriting process responsive to the underwriting information.
